(19) United States
(12) Patent Application Publication
(10) Pub. No.: US 2007/0164527 A1
(43) Pub. Date: Jul. 19, 2007

(54) FRONT SUSPENSION TUNING APPARATUS

(75) Inventors: William Mathis, Margate, FL (US); Lyew Christopher, (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Steeda Autosports, Inc., Pompano Beach, FL (US)

(21) Appl. No.: 11/623,256

(22) Filed: Jan. 15, 2007

Related U.S. Application Data
(63) Continuation of application No. 10/998,073, filed on Nov. 26, 2004, now Pat. No. 7,163,215.

(51) Int. Cl. B62D 17/00

(52) U.S. Cl. 280/86.752

(57) ABSTRACT

The present invention provides a suspension tuning device for vehicles with struts. More specifically, the suspension tuning device generally comprises a pair of plates constructed to mount juxtaposed to the strut/spindle mounting flange of a standard MacPherson strut, each plate includes an inset sub-plate having an offset aperture which cooperates with one of the spindle attachment bolts to control wheel camber.

### CROSS REFERENCE TO RELATED APPLICATION

This application is based upon and claims priority from co-pending U.S. patent application Ser. No. 10/998,073, filed on Nov. 26, 2004, the entire disclosure of both which are hereby incorporated by reference in their entirety.

### FIELD OF THE INVENTION

The present invention relates to a device for quickly and easily adjusting camber of a vehicle front suspension across a broader than normal range to tune the vehicle's suspension for racing and/or high performance street applications.

### BACKGROUND OF THE INVENTION

The versatility and performance of newer muscle cars such as the FORD MUSTANG permit owners to use one vehicle for multiple purposes. Often the same vehicle used to carry groceries home from the supermarket is used for racing applications on the weekend. Owners will often modify their vehicle to make it more competitive in their chosen form of racing. One of the most modified areas of a vehicle for racing applications is the suspension.

Front suspension tuning can be one of the most critical aspects of getting a vehicle to handle properly for either street or racing applications. Unfortunately, front suspensions that are modified exclusively for racing typically will not work properly for street driving, and street suspensions typically do not work well for racing. One of the biggest challenges for a muscle car owner who races his vehicle has been to balance the vehicle for both uses.

The front wheel of a vehicle has three main alignment angles: camber, caster, and toe. Camber is the angle at which the top of the tire is tilted inwardly or outwardly, as viewed from the front of the car. If the top of the tires lean toward the center of the car you have negative camber. If the top of the tires are tilted outward you have positive camber. Typically, as the tires are turned left and right, the camber changes slightly because the pivoting points for the tires are not vertical as viewed from the side. Adjusting camber can have a dramatic affect on the cornering characteristics of a vehicle. For example, an oval track racer will often race with negative camber on the right side of the vehicle and positive camber on the left side of the vehicle. A drag racer will often race with neutral or slightly negative camber on both sides of the vehicle and a street vehicle will typically have camber set at zero or perpendicular to the street surface.

Caster is the angle at which the pivot points for tires are tilted, as viewed from the side. Caster is best understood by imagining an axis running through the uppermost wheel pivot and extending through the lowermost pivot. From the side, if the top of the axis tilts toward the back of the car you have positive caster, if the axis line tilts toward the front of the car you have negative caster. If a vehicle has positive caster, the uppermost pivot is behind the lower pivot and this causes the tire to tilt in more at the top as the tire is steered inward (camber gain).

Changing caster primarily affects four things: high speed stability, camber gain, bump steer characteristics, and relative corner weights (wedge). Increasing caster generally increases straight line directional stability. This is good for an application such as drag racing, however, other parameters such as bump steer and wedge may be adversely affected making handling for applications such as street driving or road racing unacceptable. Excessive caster settings will increase required steering effort, cause excessive tire wear and reduce braking ability. Negative caster requires less steering effort, but directional stability is adversely affected. Some racing applications may require different caster settings on each side of the vehicle. For example, oval track racers often run more positive caster on the right side wheel than the left. The caster split helps pull the car down into the turn, helps the car turn in the center of the turn, and helps the car maintain traction exiting the turn.

Accordingly, what is lacking in the art is a suspension tuning kit for vehicles with struts. The suspension tuning kit should achieve objectives such as providing: quick adjustment, increased suspension rigidity, increased range of adjustability and reliable performance. The suspension tuning kit should include packaging flexibility for installation on various vehicle configurations including retrofitting existing vehicles with minimal modification of the original suspension system. The suspension tuning kit should facilitate independent caster and camber adjustment of each front wheel across the extended range. The suspension tuning kit should facilitate quick suspension changes to allow a vehicle to be driven to a racetrack, converted to a race setup, and thereafter quickly converted back to a street driving setup for the trip home.

### SUMMARY OF THE INVENTION

The present invention provides a suspension tuning device for vehicles with struts. More specifically, the suspension tuning device generally comprises a pair of plates constructed to mount juxtaposed to the strut/spindle mounting flange of a standard MacPherson strut, each plate includes an inset sub-plate having an offset aperture which cooperates with one of the spindle attachment bolts to control wheel camber. The cooperating plates and sub-plates permit front suspension camber alterations throughout an increased range when compared to the prior art.

The pre-existing vehicle strut tower includes a thin sheet metal mounting member constructed for attaching the upper portion of a strut member via a stamped metal plate. The mounting member typically includes three elongated slots arranged to cooperate with the stamped metal plate to permit the upper portion of the strut member to be pivoted inward for a small amount of camber adjustment. When the upper portion of the strut is pivoted inwardly or outwardly the roll center of the vehicle is altered and vehicle handling and stability may be detrimentally affected.

The instant invention provides a suspension tuning kit which operates in conjunction with, or replaces, the stamped metal strut attachment plate of the prior art. The instant invention is constructed of billet aluminum and includes a pair of camber plates. Each of the camber plates includes an inner surface and an outer surface, an upper aperture and a lower elongated aperture. The upper aperture and the lower elongated aperture are arranged to align with the pre-existing strut/spindle mounting apertures located in the OEM strut/spindle mounting flange. The camber plates include an outer contoured perimeter and a rounded lower edge which allow the plates to be snugly fit into the pre-existing strut/spindle mounting flange without interference. The plates fit within the flange sufficiently to allow the inner surfaces of the camber plates to lay juxtaposed to the outer surfaces of the strut/spindle mounting flange for a sandwich type assembly. The outer surface of each camber plate includes a generally rectangular cavity extending inwardly for accepting one of a plurality of offset-plates. The offset-plates have an outer perimeter shaped to conjugately match and fit into the camber plate cavity. Offset-plates are supplied in pairs and are constructed to include apertures positioned offset from the longitudinal centerline of the camber plates in predetermined increments for establishing the desired amount of wheel camber.

In use, the bottom surface of a camber plate is positioned juxtaposed to the outer surfaces of the strut/spindle mounting flange. Matching offset-plates are inserted into the camber plate pockets. Fasteners extend through the camber plates, the offset-plates, and the strut/spindle mounting flanges to secure the spindle in a predetermined position with respect to the strut. The offset-plates are constructed and arranged to cooperate with the existing spindle attachment bolts to control the camber angle of the spindle and thus the respective wheel. This allows the user to select a pair of offset-plates constructed to establish a desired wheel camber setting. Further alterations of camber settings merely require selecting and changing the offset-plates to a new desired set-up. Wheel camber can thus be altered throughout an increased range without changing the strut angle or the roll center of the vehicle.

In addition, the sandwich construction of the strut/spindle mounting flange and the camber plates assembly significantly increases rigidity and stability of the front suspension assembly. For further increased rigidity and stability, the kit may also include an upper strut mount adapted to replace the OEM stamped camber plate. The upper strut mount secures the upper end of the strut in a predetermined position with respect to the strut tower. The upper strut mount includes a centrally located bore constructed to cooperate with the top portion of the strut, and the outer portion of the upper strut mount includes a resilient, preferably urethane, element for isolating vibration. The upper mount is generally annular shaped with an enlarged head and preferably includes a threaded portion which extends upwardly through the mounting member of the vehicle's strut tower. A resilient element is placed on each side of the mounting member and a threaded nut cooperates with the threaded portion extending through the mounting member of the vehicle's strut tower to allow the upper portion of the strut to be secured in a selected position with respect to the strut tower.

The suspension tuning kit may be installed on either one or both sides of the front suspension of the vehicle and the camber angle of each spindle may be independently adjusted to suit the drivers needs.

Accordingly, it is an objective of the present invention to provide a suspension tuning kit for vehicles with struts.

An additional objective of the present invention is to provide a suspension tuning kit for vehicles with struts which allows wheel camber changes without alteration of the vehicle's roll center.

It is a further objective of the present invention to provide a suspension tuning kit for vehicles with struts that allows spindle angle alterations with respect to the strut to control wheel camber angle.

A still further objective of the present invention is to provide a suspension tuning kit for vehicles with struts which includes sandwich construction to provide additional rigidity and support to the vehicle suspension system.

Another objective of the present invention is to provide a suspension tuning kit for vehicles with struts which is simple to install and is ideally suited for original equipment and aftermarket installations.

Yet another objective of the present invention is to provide a suspension tuning kit for vehicles with struts that can be inexpensively manufactured, and is simple and reliable in operation.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a perspective view illustrating the front portion of a vehicle equipped with strut front suspension;

FIG. 2 is a perspective exploded view of the instant invention and a portion of the strut tower mounting member of the vehicle illustrated in FIG. 1;

FIG. 3 is a top view of the camber plate of the instant invention; and

FIG. 4 is a section view of the camber plate taken along lines 1-1 of FIG. 3.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto.

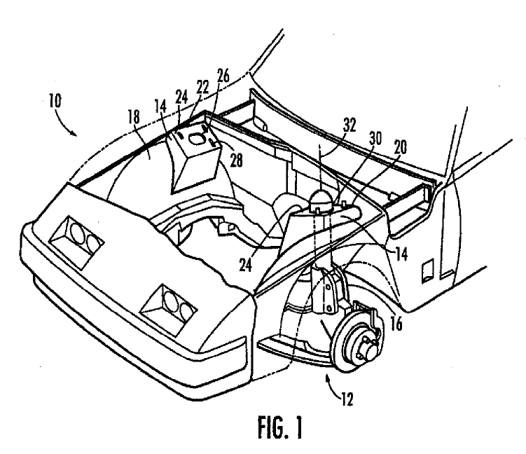

Referring to FIG. 1, the front portion of a vehicle 10 equipped with a strut suspension is shown. The strut suspension 12 includes a pair of strut towers 14. The strut towers are typically formed from sheet metal by methods well known in the art and are secured to the inner fender wall structure 18 on both the left side 20 and right side 22 of the vehicle. Each strut tower includes a mounting member 24 oriented in a plane substantially orthogonal with respect to the longitudinal axis 32 of the corresponding strut 16. The mounting member 24 generally includes a strut aperture 26 and three elongated camber adjustment slots 28. The elongated camber adjustment slots are arranged generally parallel with respect to each other and spaced around the strut axis 32. The upper end of a strut member 16 is secured to the mounting member via a stamped sheet metal member 30. The sheet metal member 30 cooperates with the three camber adjustment slots 28 to permit the upper end of the strut member to be pivoted inward toward the center of the car for a small amount of camber adjustment.

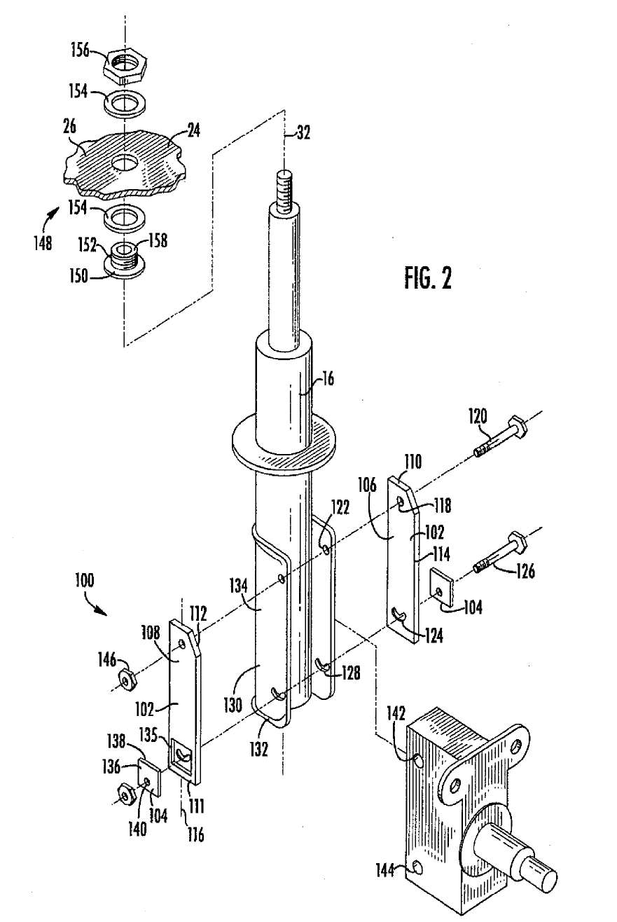

Referring to FIG. 2, an exploded view of the instant invention is illustrated in conjunction with a standard strut member 16, the spring member is omitted for clarity. The instant invention provides a suspension tuning kit 100 which replaces the stamped metal strut attachment plate 30 (FIG. 1) of the prior art. The suspension tuning kit 100 comprises a pair of camber plates 102 and at least one pair of offset-plates 104.

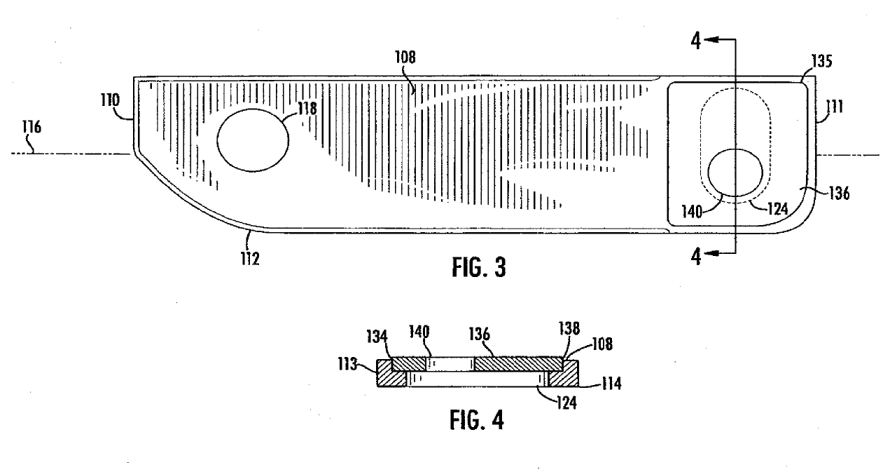

Referring to FIGS. 2-4, the camber plate 102 includes an inner surface 106, an outer surface 108, a top end 110, a bottom end 111, a contoured perimeter 112, a rounded bottom edge 114, and a longitudinal centerline 116. The top end 110 includes a first transverse bore 118 positioned generally along the longitudinal centerline 116. The first transverse bore 118 is generally positioned to align with the top spindle attachment fastener 120 and the top strut/spindle flange aperture 122. The bottom end 111 includes a second elongated transverse bore 124. The second transverse bore 124 is positioned to align with a bottom spindle attachment fastener 126 and the bottom strut/spindle flange aperture 128. While the bottom strut/spindle flange aperture 128 is generally provided from the OEM supplier as a round aperture, the instant invention preferably utilizes an elongated arcuate shaped aperture. The OEM aperture may be modified by means well known in the art such as die grinders, files, milling machines and the like.

When the inner surfaces 106 of the camber plates 102 are positioned juxtaposed to an outer surface 130 of the strut/spindle flange 134 the rounded bottom edge 114 allows the camber plate 102 to abut the depending support lip 132 without interference.

The camber plate 102 also includes a contoured cavity 135 which extends inward into the camber plate 102 from the outer surface 108 and the second transverse bore 124 is centrally located within the contoured cavity. The cavity 135 is generally constructed and arranged to secure and locate an offset-plate 136. The offset-plate 136 includes an outer perimeter 138 conjugately shaped with respect to the cavity 135 so that the offset plate 136 fits snugly into the cavity. Located in the offset-plate is an offset aperture 140. The aperture 140 is offset a predetermined amount with respect to the camber plate longitudinal centerline 116. In a most preferred embodiment the kit 100 is supplied with a plurality of pairs of offset-plates 136 with each pair having apertures 140 offset in predetermined increments. In this embodiment, each set of offset-plates are constructed to result in a different amount of wheel camber when assembled. For example, the offset plates 136 could include apertures 140 that allow camber adjustment from negative three degrees to positive six degrees. The apertures in the offset-plates are preferably positioned for one half degree increments in camber angle, however, the plates may be constructed to include any desired offset increment without departing from the scope of the invention. It should be appreciated that the cavity 135 and the cooperating offset-plates 136 could also be utilized at the top end 110 of the camber plates 102 without departing from the scope of the invention.

In a most preferred and non-limiting embodiment, the camber plates 102 are constructed of billet aluminum and are about 0.350 of an inch thick and the cavity depth is about 0.120. It should be appreciated that the camber plate 102 may be made thinner or thicker, and the cavity 135 depth may be varied as the space requirements, materials and wheel loads require. In the most preferred embodiment, the offset-plates 102 are constructed of steel and are about one eighth of an inch thick. It should also be appreciated that to accommodate space, material and wheel load requirements the camber plate 102 and/or the offset-plates 136 may alternatively be made from other ferrous or non-ferrous metals which may include, but should not be limited to, steel, titanium, brass, bronze or suitable combinations thereof.

In use, the camber plates 102 are positioned parallel and juxtaposed to the outer surface of the strut/spindle flange and offset-plates are selected for the desired wheel camber and are thereafter inserted into the cavities. Threaded fasteners 120 and 126 extend through the first and second transverse bores 118, 124, offset apertures 140, strut/spindle bores 122, 128, and spindle bores 142, 144 to cooperate with threaded nuts 146. The thickness and contour of the camber plates cooperate with the strut/spindle mounting flange 134 and its depending lip 132 to create a sandwich type of construction that has substantially increased rigidity and strength when compared to the OEM configuration. In this manner, the front wheel camber of a vehicle may be selectively adjusted throughout an extended range.

Referring to FIGS. 1 and 2, the upper strut mount 148 is illustrated. In general, the upper strut mount is constructed and arranged to replace the stamped sheet metal OEM upper strut mount 30 (FIG. 1). The upper strut mount 148 includes a head portion 150, an annular portion 152, a pair of resilient members 154, and a threaded nut member 156. The annular portion 152 includes a central bore 158 sized to fit over the upper portion of the strut member 16. The outer surface of the annular portion 152 includes integrally formed threads which cooperate with an internal threaded surface in nut member 156. In use, the central bore 158 is placed over the upper end of the strut member and the annular portion 152 is extended upwardly through the mounting member 24 of the vehicle's strut tower 14. A resilient element 154 is placed on each side of the mounting member 24 and the threaded nut cooperates with the external threads extending through the mounting member of the vehicle's strut tower to allow the upper portion of the strut to be secured in a selected position with respect to the strut tower.

In a most preferred and non-limiting embodiment, the upper mount is constructed of billet aluminum; however, it should be noted that other metals well known in the art which may include but should not be limited to steel, titanium and the like may also be utilized.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. In a front vehicle suspension, wherein said suspension includes a left and a right strut, each said strut including an upper end, a bottom end and a longitudinal centerline, said longitudinal centerline defining a strut axis, a left and a right structural strut tower, said left and said right strut towers each including a mounting member oriented in a plane substantially orthogonal with said respective left and said right strut axes, said mounting members each including a central aperture, wherein said upper end of said left strut attaches to said left strut tower mounting member via said central aperture, wherein said upper end of said right strut attaches to said right strut tower mounting member via said central aperture, wherein said bottom end of said left and said right strut includes and a flange, said flange including an upper bore and a lower bore for attachment of a spindle via an upper threaded fastener and a lower threaded fastener, a suspension tuning kit comprising:
a pair of camber plates, each having an inner surface, an outer surface, a top end, a bottom end, a contoured perimeter, and a longitudinal centerline, wherein said longitudinal centerline extends from said top end to said bottom end, said top end including a first transverse bore positioned generally along said longitudinal centerline, said first transverse bore constructed and arranged to cooperate with a top spindle attachment fastener, said bottom end including a second transverse bore, said second transverse bore constructed and arranged to cooperate with a bottom spindle attachment fastener, wherein said inner surfaces of said camber plates are positioned juxtaposed to an outer surface of said flange, wherein said inner or said outer surface of each said camber plate includes a cavity therein, wherein said cavity is constructed and arranged to accept an offset-plate, said cavity including a contoured perimeter wall, said perimeter wall surrounding at least one of said first or said second transverse bores, wherein said offset-plate includes an outer contoured perimeter shaped with respect to said contoured perimeter wall of said cavity so that said offset plate is laterally secured in a plane defined by one of the inner surface and the outer surface when accepted within said cavity, wherein said offset-plate includes an aperture therethrough, said aperture aligning with one of said first or said second transverse bores when the offset-plate is accepted by the cavity;
wherein said kit may be secured to said left or said right flange, whereby said first bore and said offset plate aperture align with said upper and said lower bores in said flange and wherein said top and bottom spindle attachment fasteners extend through said camber plates, said flange and said spindle, wherein said top and bottom spindle attachment fasteners cooperate with threaded nuts to secure said suspension tuning kit to said front vehicle suspension, wherein spindle camber angle is adjustable throughout an extended range, whereby said strut axis remains unchanged.

2. The suspension tuning kit as set forth in claim 1 including a plurality of pairs of said offset-plates, wherein each of said pair of offset-plates include apertures offset a predetermined amount to facilitate adjusting wheel camber up to about nine degrees.

3. The suspension tuning kit as set forth in claim 2, wherein each of said pairs of offset-plates include apertures offset a predetermined amount to facilitate adjusting wheel camber from about negative three degrees to about positive six degrees.

4. The suspension tuning kit as set forth in claim 2, wherein said apertures in each of said pairs of offset-plates are provided in one fourth degree increments.

5. The suspension tuning kit as set forth in claim 2, wherein said apertures in each of said pairs of offset-plates are provided in one half degree increments.

6. The suspension tuning kit as set forth in claim 2, wherein said apertures in each of said pairs of offset-plates are provided in one degree increments.

7. The suspension tuning kit as set forth in claim 1, wherein said camber plate includes at least one rounded edge extending between said inner surface and said contoured edge, wherein said rounded corner is constructed and arranged to abut a depending lip extending at least partially around the perimeter of said flange.

8. The suspension tuning kit as set forth in claim 1, wherein said camber plate is constructed from metal.

9. The suspension tuning kit as set forth in claim 1, wherein said camber plate is constructed from steel.

10. The suspension tuning kit as set forth in claim 1, wherein said camber plate is constructed from aluminum.

11. The suspension tuning kit as set forth in claim 1, wherein said camber plate is constructed from titanium.

12. The suspension tuning kit as set forth in claim 1, wherein said offset-plate is constructed from metal.

13. The suspension tuning kit as set forth in claim 1, wherein said offset-plate is constructed from steel.

14. The suspension tuning kit as set forth in claim 1, wherein said offset-plate is constructed from aluminum.

15. The suspension tuning kit as set forth in claim 1, wherein said offset-plate is constructed from titanium.

16. A camber adjuster assembly comprising:
a pair of camber adjuster plates, each camber plate of the pair of camber plates having an inner surface, an outer surface, a top end, a bottom end, a contoured perimeter, and a longitudinal centerline,
the pair of camber adjuster plates adapted to be secured to a flange of an automobile suspension strut, the flange having an upper bore and a lower bore for attachment of the spindle via an upper threaded fastener and a lower threaded fastener,
wherein the longitudinal centerline extends from the top end to the bottom end,
the top end including a first transverse bore positioned generally along the longitudinal centerline,
the first transverse bore constructed and arranged to cooperate with a top spindle attachment fastener extending through the upper bore,
the bottom end including a second transverse bore, the second transverse bore constructed and arranged to cooperate with a bottom spindle attachment fastener extending through the lower bore,
wherein the inner surfaces of each camber adjuster plate of the pair of camber adjuster plates is positioned juxtaposed to an outer surface of the flange,
wherein one of the inner and the outer surface of each camber adjuster plate comprises a cavity defined by a contoured perimeter wall surrounding at least one of the first or the second transverse bores; and
a pair of offset-plates, each offset-plate of the pair of offset plates having an outer contoured perimeter adapted to be accepted within the cavity, the outer contoured perimeter comprising dimensions to secure the offset plate laterally in a plane defined by one of the inner surface and the outer surface of a respective camber adjuster plate of the pair of camber adjuster plates,
each offset-plate of the pair of offset-plates comprising an aperture therethrough, the aperture positioned relative to the outer contoured perimeter so as to align, when the offset-plate is accepted by the cavity, with the at least one of the first or the second transverse bore that is surrounded by the contoured perimeter so as to allow one of the top spindle attachment fastener or the bottom spindle attachment fastener to extend through the aperture,
wherein the top and bottom spindle attachment fasteners cooperate with threaded nuts to secure the spindle, the pair of camber adjuster plates and the pair of offset-plates to the flange when each of the pair of offset-plates is accepted by a respective cavity of a respective camber adjuster plate within the pair of camber adjuster plates,
wherein a spindle camber angle relative to a longitudinal centerline of the automobile suspension strut is adjustable throughout an extended range based upon a position of the respective aperture of each offset-plate of the pair of offset-plates relative to the respective contoured perimeter of the respective cavity accepting the respective offset-plate.

17. The camber adjuster assembly as set forth in claim 16, further comprising a second pair of camber adjuster plates, wherein the pair of camber adjuster plates are configured to be secured to a left flange of a left automobile suspension strut, and wherein the second pair of camber adjuster plates are configured to be secured a right flange of a right automobile suspension strut.

18. A camber adjuster assembly comprising:
a pair of camber adjuster plates, each camber adjuster plate of the pair of camber adjuster plates having an inner surface, an outer surface, a top end, a bottom end, a contoured perimeter, and a longitudinal centerline,
the pair of camber adjuster plates adapted to mount to a flange of an automobile suspension strut, the flange including an upper bore and a lower bore for attachment of a spindle via an upper threaded fastener and a lower threaded fastener,
the automobile suspension strut comprising an upper end, a bottom end and a longitudinal centerline, the longitudinal centerline defining a strut axis,
the automobile suspension strut further comprising a structural strut tower including a mounting member oriented in a plane substantially orthogonal with the strut axis,
the mounting member including a central aperture, wherein the upper end of the strut attaches to the mounting member via the central aperture,
wherein the longitudinal centerline extends from the top end to the bottom end,
the top end including a first transverse bore positioned generally along the longitudinal centerline,
the first transverse bore constructed and arranged to cooperate with a top spindle attachment fastener extending through the upper bore,
the bottom end including a second transverse bore, the second transverse bore constructed and arranged to cooperate with a bottom spindle attachment fastener extending through the lower bore,
wherein the inner surface of each camber adjuster plate of the pair of camber plates is positioned juxtaposed to an outer surface of the flange,
wherein one of the inner and the outer surface of each camber adjuster plate comprises a cavity defined by a contoured perimeter wall surrounding at least one of the first or the second transverse bores; and
a pair of offset-plates, each offset plate of the pair of offset plates having an outer contoured perimeter adapted to be accepted within the cavity, the outer contoured perimeter comprising dimensions to secure the offset plate laterally in a plane defined by one of the inner surface and the outer surface of a respective camber adjuster plate of the pair of camber adjuster plates,
each offset plate of the offset-plates comprising an aperture therethrough, the aperture positioned relative to the outer contoured perimeter so as to align, when the offset-plate is accepted by the cavity, with the at least one of the first or the second transverse bore that is surrounded by the contoured perimeter so as to allow one of the top spindle attachment fastener or the bottom spindle attachment fastener to extend through the aperture,
wherein the top and bottom spindle attachment fasteners cooperate with threaded nuts to secure the spindle, the pair of camber adjuster plates and the pair of offset-plates to the flange when each of the pair of offset-plates is accepted by a respective cavity of a respective camber adjuster plate within the pair of camber adjuster plates,
wherein spindle camber angle is adjustable throughout an extended range based upon a position of the respective aperture of each offset-plate of the pair of offset-plates relative to the respective contoured perimeter of the respective cavity accepting the respective offset-plate, whereby the strut axis remains unchanged.
